(19) United States
(12) Patent Application Publication
(10) Pub. No.: US 2026/0172744 A1
(43) Pub. Date: Jun. 18, 2026

(54) ADJUSTABLE LOUDSPEAKER ASSEMBLY

(71) Applicant: HARMAN INTERNATIONAL INDUSTRIES, INCORPORATED, Stamford, CT (US)

(72) Inventors: Henrik Muusmann JORGENSEN, Struer (DK); Christian POLONYI, Munich (DE); Ole Kruse WITSCHEL, Struer (DK); Carl Alexander SANDSTROM, Struer (DK); Henrik Kirkeby JEPSEN, Vinderup (DK); Jens Jorn PEDERSEN, Holstebro (DK); Marcel PILGAARD HAVEMANN, Hjerm (DK)

(73) Assignee: HARMAN INTERNATIONAL INDUSTRIES, INCORPORATED, Stamford, CT (US)

(21) Appl. No.: 19/129,579

(22) PCT Filed: Nov. 14, 2023
(86) PCT No.: PCT/US2023/037268

§ 371 Date: May 13, 2025

Related U.S. Application Data
(60) Provisional application No. 63/425,561, filed on Nov. 15, 2022.

(51) Int. Cl. H04R 1/34; F21V 33/00; H04R 1/02; H04R 3/00; H04R 29/00

(52) U.S. Cl. CPC H04R 1/345; H04R 1/025; H04R 3/00; H04R 29/001; F21V 33/0056; H04R 2499/13

(57) ABSTRACT

A loudspeaker assembly is provided with a housing with an opening formed through and arranged about an axis. A transducer is mounted to the housing to project sound through the opening. At least one gate is mounted for adjustment relative to the axis between a closed position and an open position, wherein a distal end of the at least one gate extends over a portion of the opening in the closed position. Wherein the distal end of the at least one gate retracts along the housing in the open position to facilitate the sound projecting through the opening. An actuator is coupled to the at least one gate to adjust the at least one gate between the closed position and the open position.

### CROSS-REFERENCE TO RELATED APPLICATIONS

This application claims the benefit of U.S. provisional application Ser. No. 63/425,561 filed Nov. 15, 2022, the disclosure of which is hereby incorporated in its entirety by reference herein.

### TECHNICAL FIELD

One or more embodiments relate to a speaker system with loudspeaker assemblies that are adjustable between different positions.

### BACKGROUND

Conventional vehicles include audio systems with loudspeakers that are mounted flush with an underlying surface. Such flush mounted loudspeakers may not provide sound directly to an occupant of the vehicle, and instead reflect the sound off of one or more surfaces. A loudspeaker assembly may be mounted to extend from an underlying surface to direct sound toward an occupant of the vehicle, however such a loudspeaker assembly may be damaged during use or interfere with one or more other vehicle systems.

### SUMMARY

In one embodiment, a loudspeaker assembly is provided with a housing with an opening formed through and arranged about an axis. A transducer is mounted to the housing to project sound through the opening. At least one gate is mounted for adjustment relative to the axis between a closed position and an open position, wherein a distal end of the at least one gate extends over a portion of the opening in the closed position. Wherein the distal end of the at least one gate retracts along the housing in the open position to facilitate the sound projecting through the opening. An actuator is coupled to the at least one gate to adjust the at least one gate between the closed position and the open position.

In another embodiment, a method for controlling a loudspeaker assembly is provided. A housing is provided that is formed with a base arranged about an axis and a sidewall extending transversely from the base, wherein the sidewall is formed with an opening for facilitating sound projection through. Movement is detected proximate to the housing. At least one gate is adjusted to a closed position extending over the opening in response to movement proximate to the housing.

In yet another embodiment, a loudspeaker assembly is provided with a housing that is formed with an annular base about a longitudinal axis and a sidewall extending transversely from the base, wherein the sidewall is formed with an opening. A transducer is mounted to the base to project sound through the opening of the housing. A first gate and a second gate are mounted for rotation in opposing directions relative to each other about the longitudinal axis between a closed position and an open position. A distal end of each gate contacts each other over a central portion of the opening in the closed position, and wherein the distal ends of each gate are spaced apart from each other along a circumference of the housing in the open position to facilitate the sound projecting through the opening. Each of the first gate and the second gate are formed with a segment of a ring gear. An actuator comprising a motor is coupled to a pair of output gears by one or more intermediate gears such that the output gears rotate in opposite directions. Each output gear is configured to engage one of the ring gear segments to rotate the corresponding gate between the open position and the closed position.

### BRIEF DESCRIPTION OF THE DRAWINGS

FIG. 1 is a top perspective view of a speaker system with multiple loudspeaker assemblies mounted within a vehicle, illustrating loudspeaker assemblies arranged in open and closed positions according to one or more embodiments.

FIG. 2 is an exploded view of a loudspeaker assembly of FIG. 1.

FIG. 3 is a top perspective view of the loudspeaker assembly of FIG. 1, illustrated in a closed position without a cover.

FIG. 4 is another top perspective view of the loudspeaker assembly of FIG. 1, illustrated in a closed position without the cover and one of the gates.

FIG. 5 is a schematic diagram of a rotary actuator of the loudspeaker assembly, illustrating adjustment between the open position to the closed position.

FIG. 6 is a schematic diagram of a linear actuator of the loudspeaker assembly, illustrating adjustment between an extended position and a retracted position, according to one or more embodiments.

FIG. 7A is a top perspective view of the loudspeaker assembly of FIG. 1, illustrated in an open position.

FIG. 7B is another top perspective view of the loudspeaker assembly of FIG. 1, illustrated in a closed position.

FIG. 7C is another top perspective view of the loudspeaker assembly of FIG. 1, illustrated in a closed position and partially retracted position.

FIG. 7D is another top perspective view of the loudspeaker assembly of FIG. 1, illustrated in a closed position and retracted position.

FIG. 8 is a system diagram of the speaker system and multiple loudspeaker assemblies of FIG. 1.

FIG. 9 is a flow chart illustrating a method for controlling adjustment of a loudspeaker assembly, according to one or more embodiments.

### DETAILED DESCRIPTION

As required, detailed embodiments are disclosed herein; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

A loudspeaker assembly may be mounted to extend from an underlying surface within a vehicle to direct sound toward an occupant, however such a loudspeaker assembly may be damaged during use or interfere with one or more other vehicle systems. Therefore, it is preferred that loudspeaker assemblies are hidden or invisible when not in use.

The loudspeaker assembly is constructed in such a manner to provide translation or vertical movement. The loudspeaker assembly includes an opening that may be covered with a gate-like assembly which allows for a multidirectional, horizontal, sliding motion. In this instance the “gate” is split into two separate parts and can slide in diverging directions, separating them from each other, revealing a transducer. The “gate” is not limited to two separate elements but can also be a single element rotating to either side of the unit. The movement of the entire loudspeaker assembly can be controlled by software which allows for a dynamic movement with variable speeds and motions. The translation, or vertical movement, allows the transducer assembly to be retracted and hidden underneath the instrument panel (IP) in a storage position, thus, cleaning up the IP and protecting the transducer. In one instance the transducer can remain functional in this position while hidden.

The gate assembly may include different materials which can vary in the level of acoustic transparency. The loudspeaker assemblies may be located at either side of the IP, but could be in multiple locations, such as, but not limited to, the center IP, front or rear doors, parcel shelf, pillars, etc.

In an advantageous embodiment an illumination assembly can be integrated into the construction allowing the system to, but not limited to, be staged, for indication purposes, such as turn signals, blind-spot assist, navigation, audio settings, Bluetooth pairing mode etc. or other use cases where a multicolored illumination can be of use in the IP. The animation of the LED is not limited to static illumination, nor a single color. This can allow for a pulsing or flashing illumination to indicate the need for heightened attention of the end user. In another advantageous embodiment, the LED light can pass a prism or diffuser allowing directional and / or even illumination on the transducer or a small projection of illumination in close proximity to the loudspeaker assembly.

In one embodiment the loudspeaker assembly may be used as a protection device for the transducer as they are often very fragile. In the described assembly, the mechanism, driven by one or more electric motors, closes the aforementioned “gates” and retracts the complete unit, protecting the transducer when the system is not in use. Revealing the transducer allows the occupants of a vehicle to interact with the device and potentially harm the transducer. One manner of solving this issue is to replace or extend the mechanical protection with an active protection system that can detect when a hand is approaching the sensitive components.

The system can take one or more of these actions to prevent damage to the components: a) Block a hand from touching the transducer by mechanically closing the “gates” to the visible transducer and/or retracting the assembly into the dashboard; b) Give an acoustic warning; c) Give a visual indication with the LEDs.

An object proximate to the loudspeaker assembly may detected in several manners, for example: a) Capacitive sensing; b) A light (IR) barrier; c) Radar sensing; d) Ultrasonic sensing, possibly utilizing the speaker In a preferred embodiment the loudspeaker assembly may be used to stage the audio system in a vehicle, utilizing several mechanical movements, the transducer assembly reinforces the customer experience with unexpected behavior. A combination of sound, visuals, materials and motion provides a high-end experience for the end user.

User defined settings and preferences may be included in the software, controlling of the unit, allowing specific movements and/or use cases for the assembly, defined by the customer.

In addition to the use cases mentioned, the visual appearance of the construction may be altered by the customer, allowing different materials to be used on the “gates” and top of the assembly. These parts can snap in and be exchanged to suit the specific customer's requirements or needs.

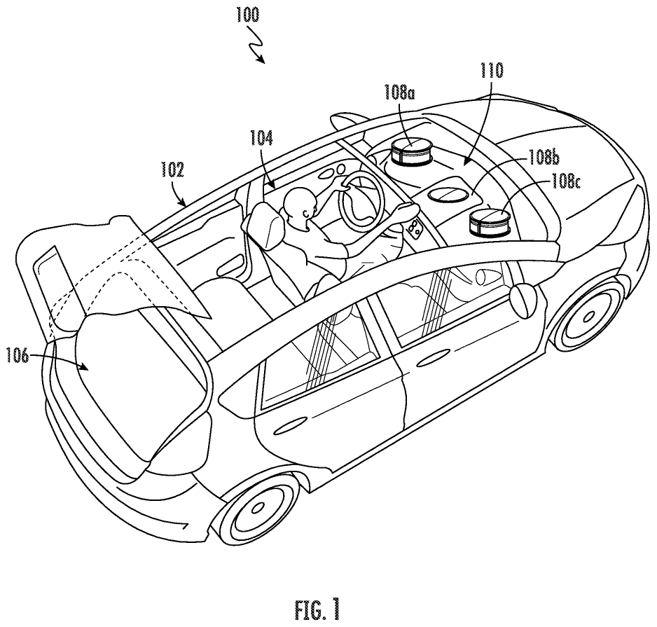

With reference to FIG. 1, a speaker system is illustrated in accordance with one or more embodiments and generally referenced by numeral 100. The speaker system 100 is illustrated within a vehicle 102 that includes a passenger compartment 104 and a storage compartment 106. The speaker system 100 includes one or more loudspeaker assemblies 108 that are mounted within the passenger compartment 104.

The speaker assemblies 108 may be located in various locations within the passenger compartment 104, such as within a dashboard 110 on either side of an instrument cluster, on the doors, parcel shelf, pillars, etc. The illustrated embodiment depicts three loudspeaker assemblies 108a, 108b, and 108c that are mounted to the dashboard 110 of the vehicle 102. The loudspeaker assemblies 108 are adjustable between an open position and a closed position. The loudspeaker assemblies 108 project sound within the passenger compartment 104 when arranged in the open position. The loudspeaker assemblies 108 are also adjustable between an extended position and a retracted position.

The speaker system 100 monitors for the presence of objects proximate to the loudspeaker assembly 108 that may damage it, e.g., a user attempting to touch it, and then adjusts the loudspeaker assembly 108 to a closed position and/or the retracted position. The first loudspeaker assembly 108a is depicted in a closed and extended position. The second loudspeaker assembly 108b is depicted in a closed and retracted position. The third loudspeaker assembly 108c is depicted in an open and extended position. The speaker system 100 may also include stationary loudspeaker assemblies that are not adjustable between open and closed positions, not shown.

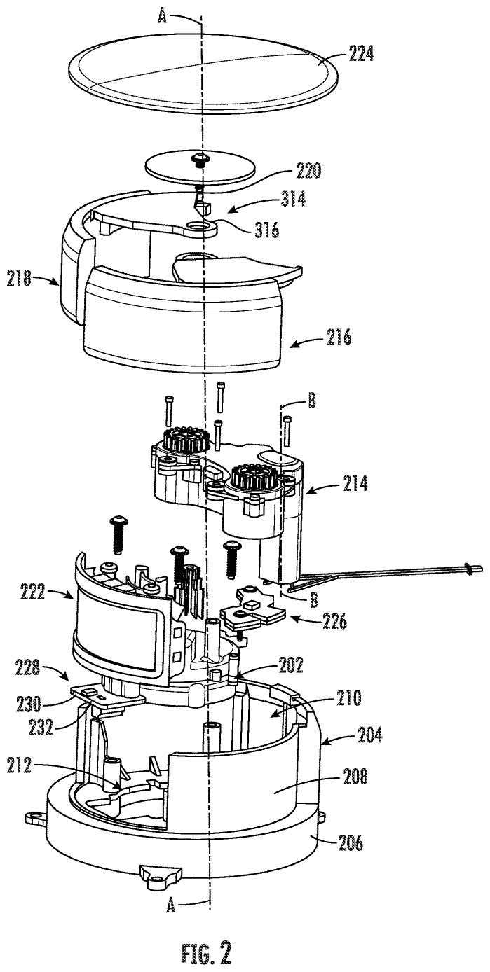

With reference to FIG. 2, the loudspeaker assembly 108 includes a transducer 202 that is mounted to a housing 204. The housing 204 includes a base 206 that is mounted to an underlying surface. The base 206 is formed in an annular shape about a longitudinal axis A-A. The housing 204 includes a sidewall 208 that extends transversely from the base 206. The sidewall 208 is formed in a generally cylindrical shape to define a cavity 210. The sidewall 208 is formed with an opening 212 formed through. The transducer 202 is mounted to the base 206 and disposed in the cavity 210 to project sound through the opening 212. The transducer 202 is a high-frequency tweeter according to one or more embodiments. In other embodiments, the transducer 202 is a mid-range or low-frequency transducer.

The loudspeaker assembly 108 includes a rotary actuator 214 for adjusting a first gate 216 and a second gate 218 about the longitudinal axis A-A between an open position and a closed position. The loudspeaker assembly 108 includes a central shaft 220 that extends along Axis A-A, and each gate 216, 218 is pivotally connected to the central shaft 220. The loudspeaker assembly 108 includes a screen 222 that is disposed over the transducer 202. The loudspeaker assembly 108 includes a cover 224 that attaches to a distal end of the sidewall 208, that together with the screen 222, enclose the transducer 202, the rotary actuator 214, and the gates 216, 218 within the cavity 210.

The loudspeaker assembly 108 includes a sensor 226 to monitor movement proximate to the housing. For example, the sensor 226 may detect a hand of a user proximate to the housing 204. The sensor 226 is mounted to the base 206 within the cavity 210. The sensor 226 may be a capacitive sensor to detect contact with the housing 204 or one or more ranging sensors, such as a light sensor, a radar sensor, or an ultrasonic sensor that detect distance.

The loudspeaker assembly 108 includes an illumination assembly 228 to convey information to one or more occupants of the vehicle 102. The illumination assembly 228 includes a light emitting device 230, such as a light emitting diode (LED), that is mounted to a circuit board assembly 232, according to the illustrated embodiment. The illumination assembly 228 may be controlled to emit light in response to movement detected by the sensor 226.

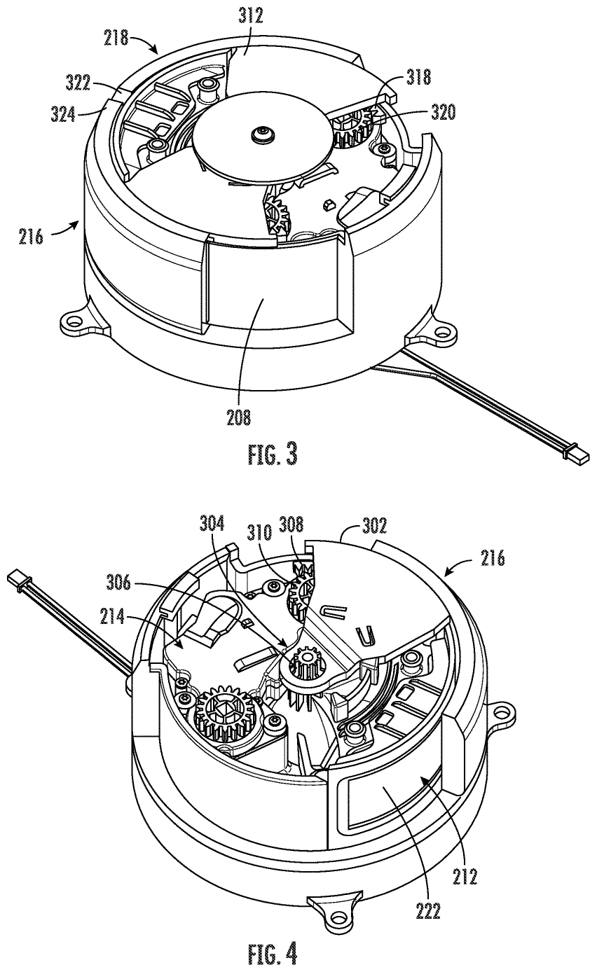

Referring to FIGS. 3 and 4, the first gate 216 is formed in an arcuate shape that corresponds with a circumference of the sidewall 208. A first plate 302 extends transversely from an upper portion of the first gate 216. The first plate 302 includes a distal end 304 with an aperture 306 formed through that is aligned with the longitudinal axis A-A (shown in FIG. 2). A first ring gear segment 308 extends transversely from the first plate 302 proximate to the first gate 216. The rotary actuator 214 includes a first output gear 310 that engages the first ring gear segment 308 to adjust the first gate 216.

The second gate 218 is formed in an arcuate shape that corresponds with a circumference of the sidewall 208. A second plate 312 extends transversely from an upper portion of the second gate 218. The second plate 312 includes a distal end 314 with an aperture 316 formed through that is aligned with the longitudinal axis A-A (shown in FIG. 2). A second ring gear segment 318 extends transversely from the second plate 312 proximate to the second gate 218. The rotary actuator 214 includes a second output gear 320 that engages the second ring gear segment 318 to adjust the second gate 218 between the open position and the closed position.

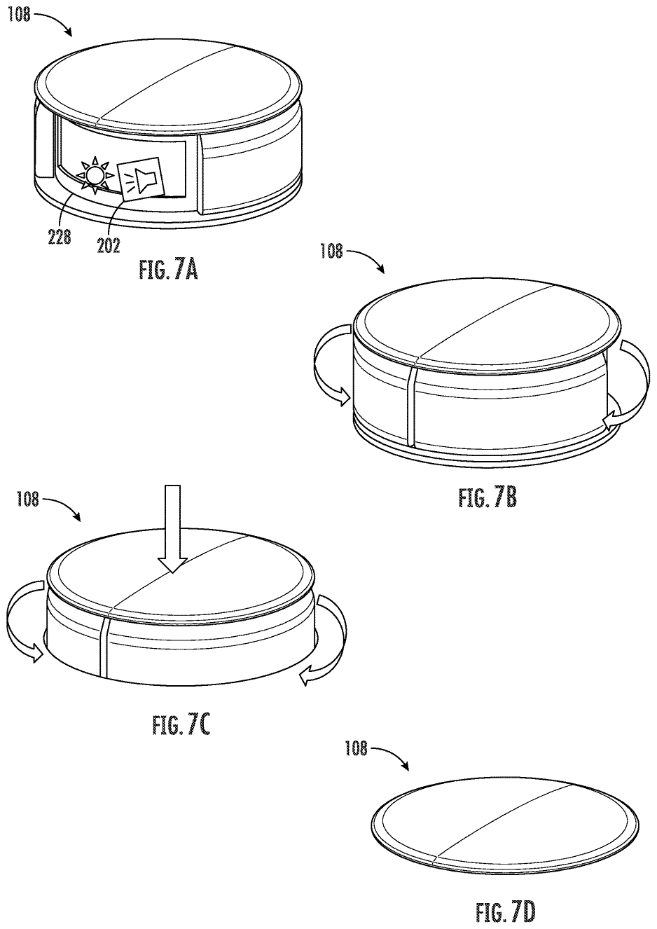

The rotary actuator 214 rotates the first gate 216 and the second gate 218 in opposing directions relative to each other about the longitudinal axis A-A between the closed position and the open position. The first gate 216 includes a distal end 322 and the second gate 218 includes a distal end 324. The distal ends 322, 324 of the gates 216, 218 contact each other over a central portion of the opening 212 to enclose the screen 222 of the transducer 202 within the cavity 210 when the gates 216, 218 are arranged in the closed position, as shown in FIG. 3. The distal ends 322, 324 of the gates 216, 218 are spaced apart from each other along a circumference of the housing 204 in the open position, as shown in FIG. 7A, to facilitate projecting sound from the transducer 202 through the opening 212.

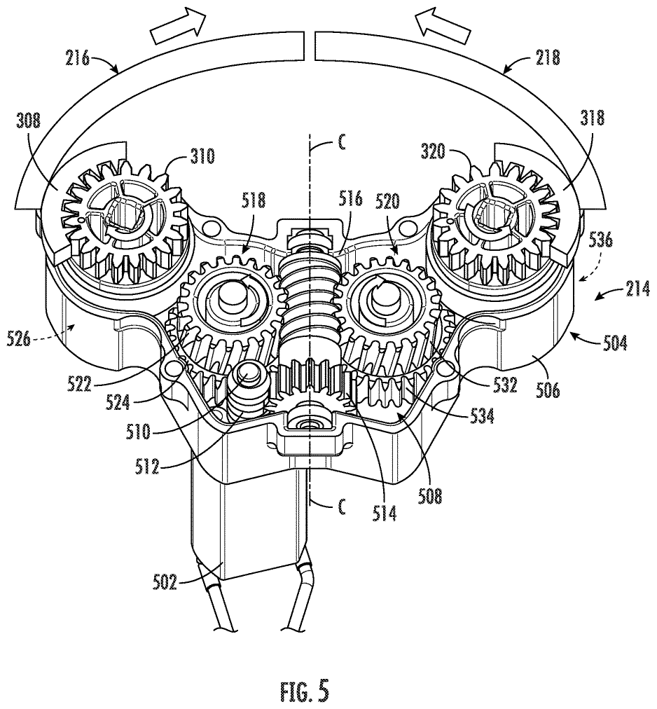

With reference to FIG. 5, the rotary actuator 214 includes a motor 502 and a transmission 504 that are supported by a housing 506. The motor 502 is a direct current motor that is connected to a vehicle battery (not shown), according to one or more embodiments. The housing 506 defines a cavity 508. The motor 502 is mounted to the housing 506 and includes a motor shaft 510 that extends into the cavity 508 along a motor axis B-B that is aligned in parallel with the longitudinal axis A-A (shown in FIG. 2). A worm 512 is attached to the motor shaft 510.

The transmission 504 includes a worm wheel 514 that is mounted for rotation about a worm axis C-C that is arranged transversely relative to the motor axis B-B. The worm wheel 514 meshes with the worm 512 to transfer motor torque to the transmission 504. The transmission 504 includes a worm screw 516 that extends from the worm wheel 514 along the worm axis C-C.

The transmission 504 includes a first compound idler gear drive 518 and a second compound idler gear drive 520 that mesh with opposing sides of the worm screw 516 to rotate in opposite directions. The first compound idler gear drive 518 includes a first helical gear 522 and a first spur gear 524 that are coaxially aligned. The first helical gear 522 meshes with the worm screw 516. The first output gear 310 is part of a compound output gear drive that also includes a first output spur gear 526 (not shown). The first spur gear 524 meshes with the first output spur gear 526 to transfer the motor torque through the transmission to the first ring gear segment 308.

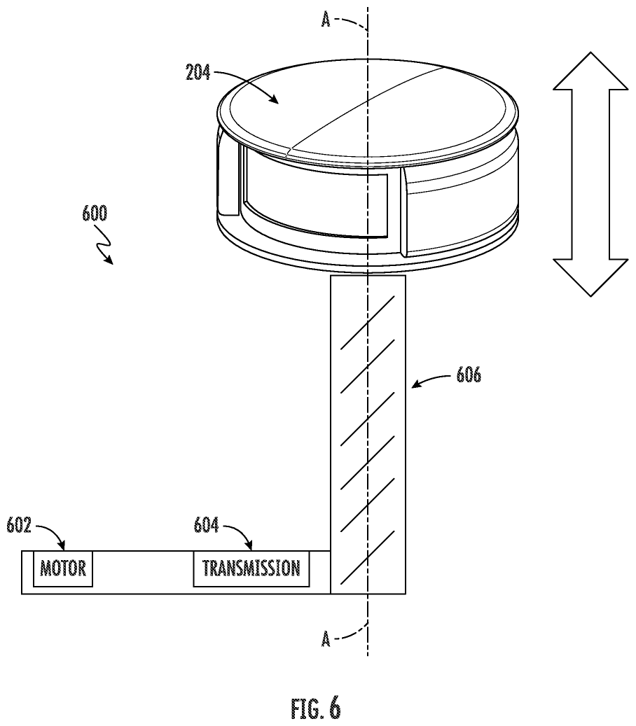

The second compound idler gear drive 520 includes a second helical gear 532 and a second spur gear 534 that are coaxially aligned. The second helical gear 532 meshes with the worm screw 516. The second output gear 320 is part of a compound output gear drive that also includes a second output spur gear 536 (not shown). The second spur gear 534 meshes with the second output spur gear 536 to transfer the motor torque through the transmission to the second ring gear segment 318 With reference to FIG. 6, the loudspeaker assembly 108 includes a linear actuator 600 for adjusting the housing 204 along the longitudinal axis A-A between an extended position and a retracted position, according to one or more embodiments. The linear actuator 600 includes a motor 602 that is coupled to a transmission 604. The transmission 604 includes a lead screw 606 that is connected to the housing 204 to translate the housing 204 between the extended position and a retracted position. In one or more embodiments, a single actuator provides the functionality of both the rotary actuator 214 and the linear actuator 600.

FIGS. 7A-7D illustrate adjustment of the loudspeaker assembly 108 between the open position and the closed position, and between the extended position and the retracted position. FIG. 7A illustrates the loudspeaker assembly 108 in an open and extended position. FIG. 7B illustrates the loudspeaker assembly 108 in a closed and extended position. FIG. 7C illustrates the loudspeaker assembly 108 in a closed and partially retracted position. FIG. 7D illustrates the loudspeaker assembly 108 in a closed and retracted position.

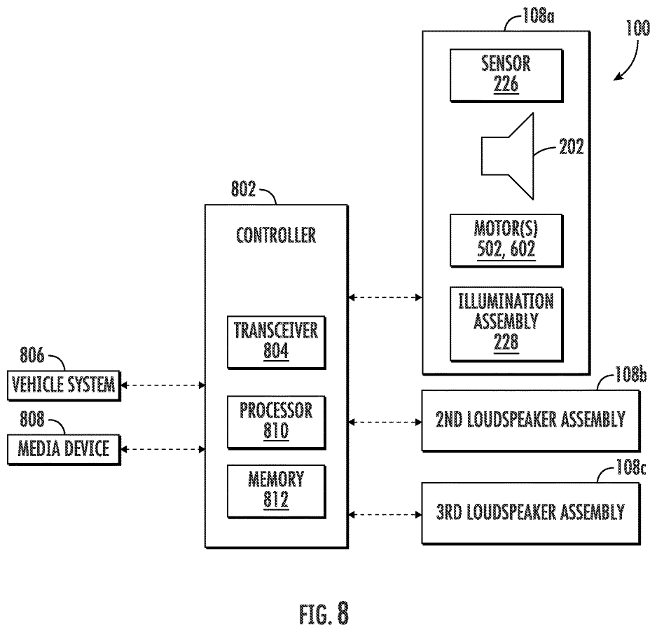

With reference to FIG. 8, the speaker system 100 includes a controller 802 for controlling the adjustment of each loudspeaker assembly 108. The controller 802 includes a transceiver 804 for communicating with each sensor 226 to receive input indicative of motion proximate to the loudspeaker assembly 108. The controller 802 may then control the motor 502 of the rotary actuator 214 and/or the motor 602 of the linear actuator 600 to adjust the loudspeaker assembly between the open and closed positions and the extended and retracted positions. The controller 802 may also control the illumination assembly 228 to convey information to a user of the vehicle 102.

The controller 802 also communicates with one or more vehicle systems 806 to receive vehicle information, e.g., of a vehicle accident and then control the actuators 214, 600 to adjust the loudspeaker assembly 108 prior to the accident. The controller 802 may also receive information that another vehicle system 806 is using the same location of the vehicle 102 as the loudspeaker assembly 108 for another purpose, e.g., to project an image onto the dashboard, and then control the actuators 214, 600 to adjust the loudspeaker assembly 108 prior to the overlapping usage.

The controller 802 also communicates with a media device 808, such as a head-unit of an audio system, to receive media content, such as audio files. The controller 802 provides audio signals to the loudspeaker assembly 108 based on the media content using the transceiver 804. In other embodiments, the media device 808 may communicate with the loudspeaker assembly 108 through wired communication and/or provide other media content, e.g., video signals. The media device 808 also includes one or more receivers (not shown) for receiving signals from an external source (e.g., AM, FM, satellite and HD signals), according to one or more embodiments.

The controller 802 includes a processing unit, or processor 810, that may include any number of microprocessors, GPUs, ASICs, ICs, memory (e.g., FLASH, ROM, RAM, EPROM and/or EEPROM) and software code to co-act with one another to perform a series of operations. Such hardware and/or software may be grouped together in assemblies to perform certain functions. Any one or more of the controllers or devices described herein include computer executable instructions that may be compiled or interpreted from computer programs created using a variety of programming languages and/or technologies. The controller 802 also includes memory 812, or non-transitory computer-readable storage medium, that is capable of storing instructions of a software program. The memory 812 may be, but is not limited to, an electronic storage device, a magnetic storage device, an optical storage device, an electromagnetic storage device, a semi-conductor storage device, or any suitable combination thereof. In general, the processor 810 receives instructions, for example from the memory 812, a computer-readable medium, or the like, and executes the instructions. The controller 802 also includes predetermined data, or “look up tables” that is stored within the memory 812, according to aspects of the disclosure.

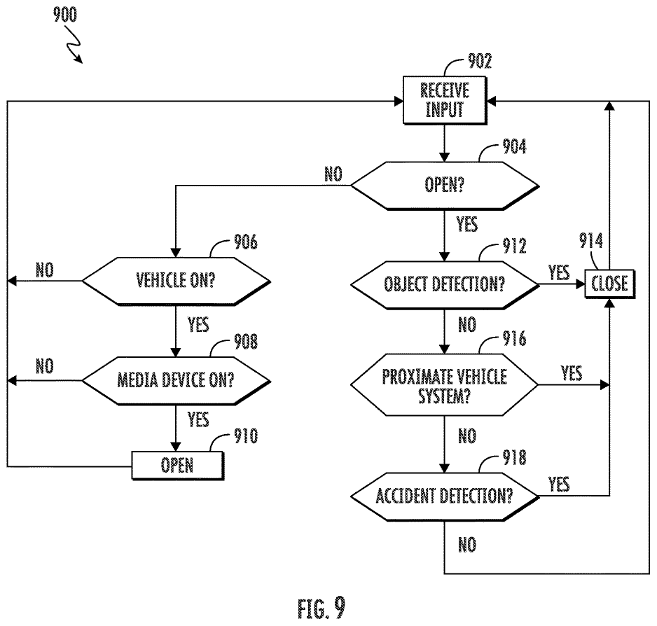

With reference to FIG. 9, a flow chart depicting a method for controlling adjustment of a loudspeaker assembly is illustrated in accordance with one or more embodiments and is generally referenced by numeral 900.

The method 900 is implemented using software code that is executed by the processor 810 and contained within the memory 812 of the controller 802 according to one or more embodiments. While the flowchart is illustrated with a number of sequential steps, one or more steps may be omitted and/or executed in another manner without deviating from the scope and contemplation of the present disclosure.

At step 902, the controller 802 receives input, such as motion data from the sensor 226 and vehicle information from the vehicle system 806. The motion data may also be indicative of the position of the loudspeaker assembly 108. The vehicle information may include accident information, overlapping usage information, vehicle on/off status information, and audio system status information.

At step 904 the controller 802 determines if the loudspeaker assembly 108 is in an open position based on the input. If the loudspeaker assembly is closed, i.e., not open, the controller 802 proceeds to step 906 to determine if the vehicle 102 is on, and then to step 908 to determine if the media device 808 is on. If both the vehicle 102 and the media device 808 are on, the controller 802 proceeds to step 910 and controls the rotary actuator 214 to open the loudspeaker assembly 108. If the controller 802 determines that the loudspeaker assembly 108 is open at step 904, it proceeds to step 912.

At step 912 the controller 802 evaluates the input to determine if an object, e.g., a hand, is detected proximate to the loudspeaker assembly 108. If a proximate object is detected, the controller 802 proceeds to step 914 and controls the rotary actuator 214 to close the loudspeaker assembly 108. In one or more embodiments, the controller 802 also controls the linear actuator 600 to retract the loudspeaker assembly 108. If no proximate object is detected, the controller 802 proceeds to step 916. At step 916, the controller 802 evaluates the input to determine if a vehicle system is using the same space as the loudspeaker assembly 108, and if so, the controller 802 proceeds to step 914 and controls the rotary actuator 214 to close the loudspeaker assembly 108. If no proximate, or overlapping, vehicle system usage is detected, the controller 802 proceeds to step 918. At step 918, the controller 802 evaluates the input to determine if an accident is detected, and if so, the controller 802 proceeds to step 914 and controls the rotary actuator 214 to close the loudspeaker assembly 108.

While exemplary embodiments are described above, it is not intended that these embodiments describe all possible forms. Rather, the words used in the specification are words of description rather than limitation, and it is understood that various changes may be made without departing from the spirit and scope of the disclosure. Additionally, the features of various implementing embodiments may be combined to form further embodiments.

What is claimed is:

1. A loudspeaker assembly comprising:
a housing with an opening formed through and arranged about an axis;
a transducer mounted to the housing to project sound through the opening;
at least one gate mounted for adjustment relative to the axis between a closed position and an open position, wherein a distal end of the at least one gate extends over a portion of the opening in the closed position, and wherein the distal end of the at least one gate retracts along the housing in the open position to facilitate the sound projecting through the opening; and
an actuator coupled to the at least one gate to adjust the at least one gate between the closed position and the open position.

2. The loudspeaker assembly of claim 1, wherein the at least one gate further comprises a first gate and a second gate, each of the first gate and the second gate being formed in an arcuate shape and mounted for rotation in an opposing direction relative to the other of the first gate and the second gate about the axis between the closed position and the open position.

3. The loudspeaker assembly of claim 2, wherein the distal ends of the first gate and the second gate contact each other over a central portion of the opening in the closed position, and wherein the distal ends of the first gate and the second gate are spaced apart from each other along a circumference of the housing in the open position to facilitate the sound projecting through the opening.

4. The loudspeaker assembly of claim 3, wherein each of the first gate and the second gate comprise a ring gear segment, the actuator comprising:
a motor coupled to a pair of output gears by one or more intermediate gears such that the output gears rotate in opposite directions, each output gear being configured to engage one of the ring gear segments to rotate the corresponding gate between the open and closed position.

5. The loudspeaker assembly of claim 4, wherein the actuator further comprises:
a motor shaft extending from the motor along a motor axis aligned in parallel with the axis;
a first worm attached to the motor shaft;
a wormset mounted for rotation about a worm axis arranged transversely relative to the motor axis, the wormset comprising a worm gear to engage the first worm and a second worm;
a pair of compound idler gears, each compound idler gear comprising a first gear to engage the second worm and a second gear, each compound idler gear being arranged on opposing sides of the second worm to rotate in an opposite direction as the other compound idler gear; and
a pair of compound output gears, each compound output gear comprising a first output gear to engage one of the ring gear segments and a second output gear to engage the second gear.

6. The loudspeaker assembly of claim 1 further comprising:
a sensor to monitor movement about the housing; and
a controller in communication with the sensor and programmed to control the actuator to adjust the at least one gate to the closed position in response to movement proximate to the housing.

7. The loudspeaker assembly of claim 6, wherein the sensor comprises at least one of a capacitive sensor, a light sensor, a radar sensor, and an ultrasonic sensor.

8. The loudspeaker assembly of claim 6 further comprising:
a linear actuator coupled to the housing and configured to adjust the housing along the axis between an extended position and a retracted position, wherein the housing is at least partially disposed beneath a surface in the retracted position.

9. The loudspeaker of claim 8, wherein the controller is further programmed to control the linear actuator to adjust the housing to the retracted position in response to movement proximate to the housing.

10. The loudspeaker assembly of claim 6 further comprising:
at least one light emitting device supported by the housing;
wherein the controller is further programmed to control the at least one light emitting device to emit light in response to movement proximate to the housing.

11. The loudspeaker assembly of claim 10, wherein the at least one light emitting device further comprises a light emitting diode.

12. The loudspeaker assembly of claim 6, wherein the controller is further programmed to:
control the actuator to adjust the at least one gate to the closed position in response to input indicative of at least one of a vehicle accident and overlapping usage indicative of a device or feature that occupies the same space as the loudspeaker assembly.

13. The loudspeaker assembly of claim 6, wherein the controller is further programmed to control the actuator to adjust the at least one gate to the open position in response to vehicle status information and audio system status information.

14. A method for controlling a loudspeaker assembly comprising:
detecting movement proximate to a sound projection opening of a speaker housing; and
adjusting at least one gate to a closed position extending over the sound projection opening in response to movement proximate to the speaker housing.

15. The method of claim 14 further comprising;
retracting the speaker housing in response to detecting movement proximate to the housing.

16. The method of claim 14 further comprising:
emitting light in response to detecting movement proximate to the housing.

17. The method of claim 14, further comprising:
closing the at least one gate in response to detecting at least one of a vehicle accident and overlapping usage indicative of a device or feature that occupies the same space as the loudspeaker assembly.

18. The method of claim 14, further comprising:
opening the at least one gate in response to vehicle status information and audio system status information.

19. A loudspeaker assembly comprising:
a housing formed with an annular base about a longitudinal axis and a sidewall extending transversely from the base, wherein the sidewall is formed with an opening;
a transducer mounted to the base to project sound through the opening of the housing;
a first gate and a second gate mounted for rotation in opposing directions relative to each other about the longitudinal axis between a closed position and an open position, wherein a distal end of each gate contacts each other over a central portion of the opening in the closed position, and wherein the distal ends of each gate are spaced apart from each other along a circumference of the housing in the open position to facilitate the sound projecting through the opening, each of the first gate and the second gate being formed with a ring gear segment; and
an actuator comprising a motor coupled to a pair of output gears by one or more intermediate gears such that the output gears rotate in opposite directions, each output gear being configured to engage one of the ring gear segments to rotate the corresponding gate between the open and closed position.

20. The loudspeaker assembly of claim 19 further comprising:
a sensor to monitor movement proximate to the housing; and
a controller in communication with the sensor and programmed to control the actuator to adjust the first gate and the second gate to the closed position in response to movement proximate to the housing.
